(19) United States
(12) Patent Application Publication
(10) Pub. No.: US 2023/0318182 A1
(43) Pub. Date: Oct. 5, 2023

(54) ANTENNA RADIATOR, AND ANTENNA

(71) Applicant: Telefonaktiebolaget LM Ericsson (publ), Stockholm (SE)

(72) Inventor: Haitao LIU, Beijing (CN)

(73) Assignee: Telefonaktiebolaget LM Ericsson (publ), Stockholm (SE)

(21) Appl. No.: 18/021,008

(22) PCT Filed: Aug. 13, 2020
(86) PCT No.: PCT/CN2020/108927

§ 371 Date: Feb. 13, 2023

(51) Int. Cl. H01Q 1/48; H01Q 9/04

(52) U.S. Cl. CPC H01Q 9/0407; H01Q 1/48

(57) ABSTRACT

The present disclosure relates to an antenna radiator, and an antenna. An antenna radiator comprises: a planar body; at least one slot located in the planar body; and at least one notch located on at least one outer side of the planar body, respectively. The at least one slot crosses a center of the planar body, to basically divide the planar body to at least four radiation blocks. A notch of the at least one notch is located between two adjacent radiation blocks of the at least four radiation blocks. A length direction of the notch extends along an outer side of the planar body at which the notch is located. According to embodiments of the present disclosure, the frequency bandwidth of the antenna radiator may be enlarged, without enlarging the overall size.

### TECHNICAL FIELD

The present disclosure relates generally to the wireless communication technology, and in particular, to an antenna radiator, and an antenna.

### BACKGROUND

This section introduces aspects that may facilitate better understanding of the present disclosure. Accordingly, the statements of this section are to be read in this light and are not to be understood as admissions about what is in the prior art or what is not in the prior art.

As the development of the communication technology, a more compact communication device, either a network node/device or a terminal device, is always expected. Meanwhile, the lager frequency bandwidth is used for desires of high communication rate and/or data amount, etc. Therefore, it is always desired for an antenna with smaller size but lager frequency bandwidth.

### SUMMARY

Certain aspects of the present disclosure and their embodiments may provide solutions to these or other challenges. There are, proposed herein, various embodiments which address one or more of the issues disclosed herein.

A first aspect of the present disclosure provides an antenna radiator, comprising: a planar body; at least one slot located in the planar body; and at least one notch located on at least one outer side of the planar body, respectively. The at least one slot crosses a center of the planar body, to basically divide the planar body to at least four radiation blocks. A notch of the at least one notch is located between two adjacent radiation blocks of the at least four radiation blocks. A length direction of the notch extends along an outer side of the planar body at which the notch is located.

In embodiments of the present disclosure, the notch comprises at least two rectangle parts adjacent in a depth direction; and the depth direction is basically perpendicular to the outer side of the planar body.

In embodiments of the present disclosure, a ratio of lengths of two adjacent rectangle parts of the at least two rectangle parts is a predetermined value; a ratio of depths of two adjacent rectangle parts of the at least two rectangle parts is the predetermined value; in the at least two rectangle parts, a first rectangle part further away from the outer side of the planar body has a first length less than a second length of a second rectangle part closer to the outer side of the planar body.

In embodiments of the present disclosure, the notch is located with a distance to the at least one slot; and the distance is associated with predetermined value.

In embodiments of the present disclosure, the distance d0 is basically equal to

$$\frac{d 1}{β \times K} ;$$

and d1 is a depth of a rectangle part, that is closest to the at least one slot, among the at least two rectangle parts, K is the predetermined value, β is a tuning factor.

In embodiments of the present disclosure, the planar body is basically in a form of square.

In embodiments of the present disclosure, the at least one slot comprises a first slot and second slot basically perpendicular with each other; the first slot extends basically perpendicularly to a first outer side and a third outer side of the planar body, the third outer side is opposite to the first outer side; and the second slot extends basically perpendicularly to a second outer side and a fourth outer side of the planar body, the fourth outer side is opposite to the second outer side.

In embodiments of the present disclosure, the at least one notch comprises: a first notch located at the first outer side of the planar body; a second notch located at the second outer side of the planar body; a third notch located at the third outer side of the planar body; and a fourth notch located at the fourth outer side of the planar body.

In embodiments of the present disclosure, the at least four radiation blocks comprise four radiation blocks.

In embodiments of the present disclosure, each of the at least four radiation blocks has at least one hole located on a diagonal line of the planar body.

In embodiments of the present disclosure, a feeding point of each of the at least four radiation blocks is located on a diagonal line of the planar body.

In embodiments of the present disclosure, the feeding point is connected to feeding network though a feeding pin; the feeding pin further supports the each of the at least four radiation blocks with a height over a dielectric substrate.

In embodiments of the present disclosure, the at least four radiation blocks are symmetry with each other around the center of the planar body.

In embodiments of the present disclosure, two radiation blocks of the at least four radiation blocks located on a same diagonal line form a pair.

A second aspect of the present disclosure provides an antenna, comprising: an antenna radiator according to any embodiment of the first aspect of the present disclosure; and a dielectric substrate. The antenna radiator is electrically coupled to a feeding network arranged on the dielectric substrate.

In embodiments of the present disclosure, the antenna further comprises a grounded metal plate arranged on the dielectric substrate.

According to embodiments of the present disclosure, an arrangement of the at least one slot and the at least one notch may provide the antenna radiator with capability to specify the surface currents’ distribution on the antenna radiator. Therefore, the frequency bandwidth of the antenna radiator may be enlarged by adjusting the shape of the at least one slot and/or the at least one notch, without enlarging the overall size of the antenna radiator.

### BRIEF DESCRIPTION OF DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 is an exemplary diagram showing a top view of an antenna radiator according to embodiments of the present disclosure.

FIG. 2A is an exemplary diagram showing more details of the antenna radiator according to embodiments of the present disclosure.

FIG. 2B is an exemplary diagram showing surface current distribution of the antenna radiator, according to embodiments of the present disclosure.

FIG. 2C is an exemplary diagram showing a magnetic field vector direction of the surface current of the antenna radiator, according to embodiments of the present disclosure.

FIG. 2D is another exemplary diagram showing more details of the antenna radiator according to embodiments of the present disclosure.

FIG. 2E is another exemplary diagram showing a magnetic field vector direction of the surface current of the antenna radiator, according to embodiments of the present disclosure.

FIG. 2F is an exemplary diagram showing a bandwidth of the antenna radiator, according to embodiments of the present disclosure.

FIG. 3 is an exemplary diagram showing a side view of an antenna radiator according to embodiments of the present disclosure.

FIG. 4 is an exemplary diagram showing an antenna according to embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the term “network” or “communication network” refers to a network following any suitable wireless communication standards. For example, the wireless communication standards may comprise 5^{th} generation (5G), new radio (NR), 4^{th} generation (4G), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

Currently, one of the most popular antenna types is the “resonant antenna” whose frequency depends on wavelength. Generally speaking, the length of the antenna is integer times of quarter-wavelength. One common issue of this type antenna is that its bandwidth is limited.

Particularly, square shaped patch is widely used as an electro-magnetic wave radiator. The simple and regular shape provides the low-cost feature, but the band width might be limited. On the other hand, a radio with wider bandwidth is demanded by the communication industry. Therefore, techniques that can enlarge the radiator’s bandwidth need to be established.

Another typical antenna type used by base-stations are dipole antennas. When think about the Half-Wavelength Dipole Antenna, the antenna design is specified by the length. The length should be equal to a half-wavelength at the frequency of interest. One problem with the above Half-Wavelength antenna design is that the design depends solely on length and its bandwidth are limited by the antenna size.

Log-periodic antennas are designed for the specific purpose of having a very wide bandwidth. The achievable bandwidth is theoretically infinite; the actual bandwidth achieved is dependent on how large the structure is. Therefore, the issue of log-periodic antenna is challenge of size and it is not suitable for being integrated into rather compact devices, such as active antenna system (AAS) base station. Further, the Log-periodic antenna is single polarized and many devices, such as AAS base station, require dual Polarization.

Therefore, how to achieve wideband within a small sized antenna is the issue targeted by this disclosure. This disclosure relates to the technical field of communication industry, especially to the Electro-Magnetic Wave Radiator and the antenna including the same used by the communication equipment’s. More particular, this disclosure relates to the surface current constraining technique that enables a compact wideband antenna element that may also reside in the phased array.

The bandwidth of an electromagnetic radiator is highly related with its surface current’s distribution. Those antennas whose surface currents are specified by length cannot realized a wide bandwidth within a given and limited compact size. Those antennas whose surface currents are specified by angles (namely, the surface current changes along different angle positions) can realize a wide bandwidth within a given and limited compact size. Because angles do not depend on distance - and hence don’t depend on wavelength and size.

The root cause of antennas depending on angles can realize a wide bandwidth is that its surface current’s distribution is specified by angles. When the surface currents’ distribution is completely specified by angles, an antenna whose frequency and bandwidth is basically independent from the radiator’s physical size.

In the present disclosure, in order to design a wideband antenna within a compact size, an antenna whose surface currents were completely specified by angles instead of lengths is design. Further, an exponential curve is a typical curvature specified by angles.

Therefore, how to shape the surface current (particularly, how to shape the surface current of a compact patch to have exponential curve) by specific structures may be illustrated in this disclosure.

In the present disclosure, by introducing precisely designed notches, slots and/or holes, the surface current on the proposed radiator can be constrained and forced to resonate along an exponential curve which depend on angles instead of wavelength. By this means, a wide bandwidth can be realized within the compact size.

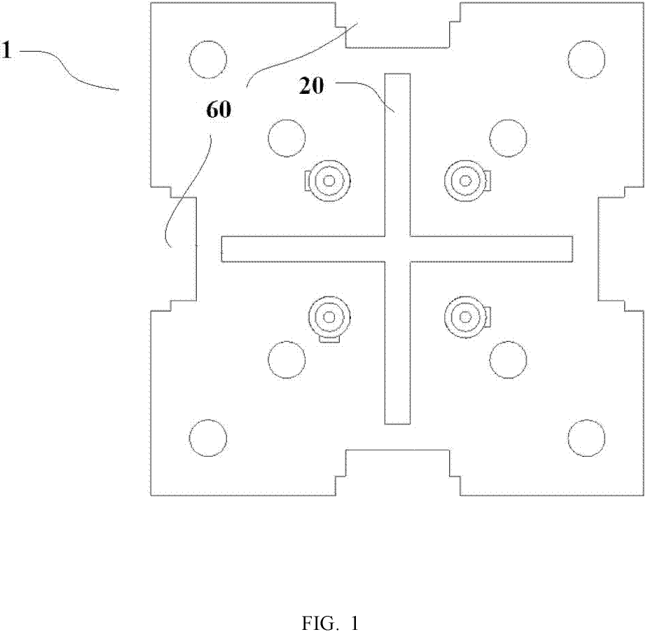

FIG. 1 is an exemplary diagram showing a top view of an antenna radiator according to embodiments of the present disclosure.

As shown in FIG. 1, the antenna radiator may comprise: a planar body 1; at least one slot 20 located in the planar body; and at least one notch 60 located on at least one outer side (namely, the outer side edge) of the planar body 1, respectively. The at least one slot 20 crosses a center of the planar body, to basically divide the planar body 1 to at least four radiation blocks. A notch of the at least one notch 60 is located between two adjacent radiation blocks of the at least four radiation blocks. A length direction of the notch extends along an outer side of the planar body at which the notch is located.

According to embodiments of the present disclosure, an arrangement of the at least one slot and the at least one notch may provide the antenna radiator with capability to specify the surface currents’ distribution on the antenna radiator.

Specifically, the surface current on the proposed radiator can be constrained and forced to resonate basically along the edge of the at least one slot and the at least one notch, and such current propagation path may be further adjusted to be an exponential curve which depend on angles instead of wavelength.

Therefore, the frequency bandwidth of the antenna radiator may be enlarged by adjusting the shape of the at least one slot and/or the at least one notch, without enlarging the overall size of the antenna radiator.

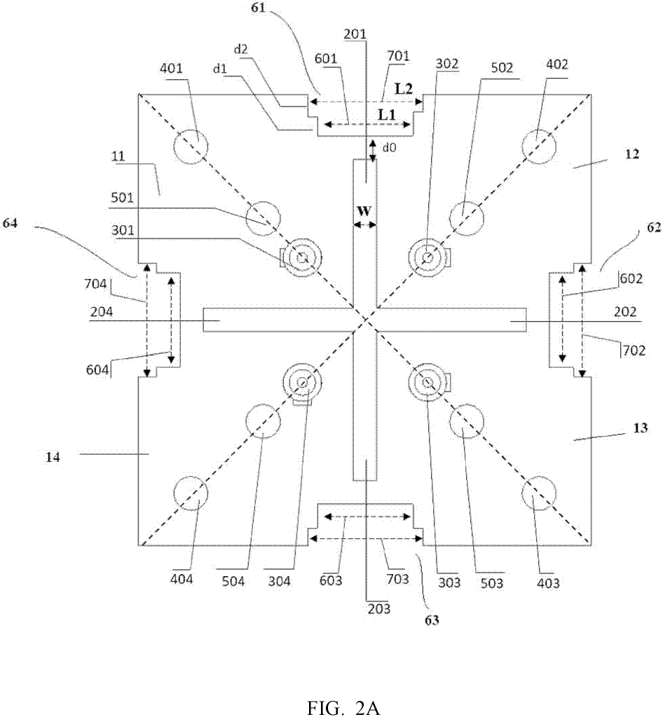

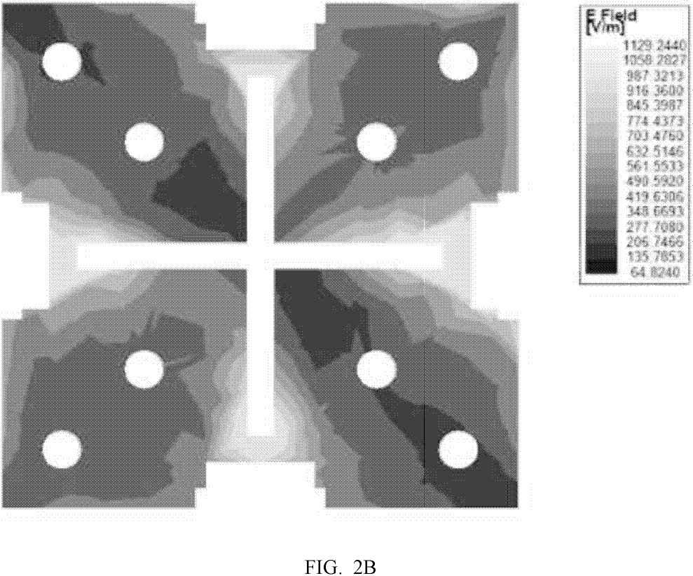

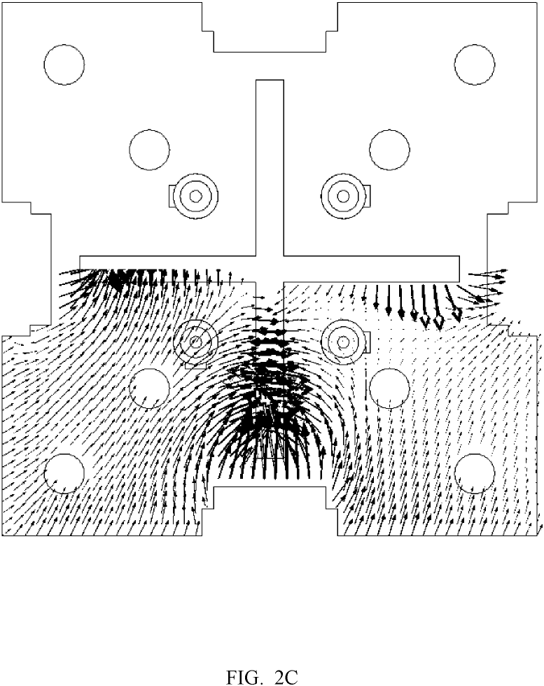

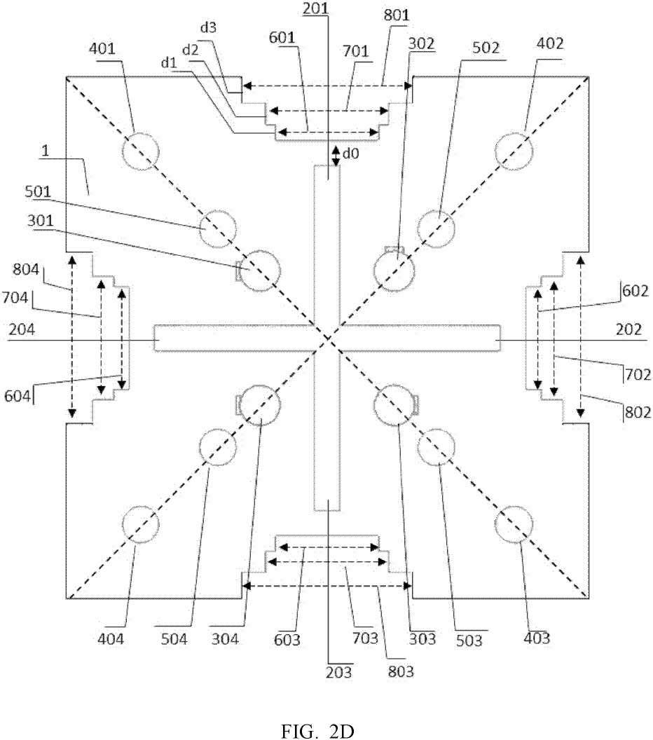

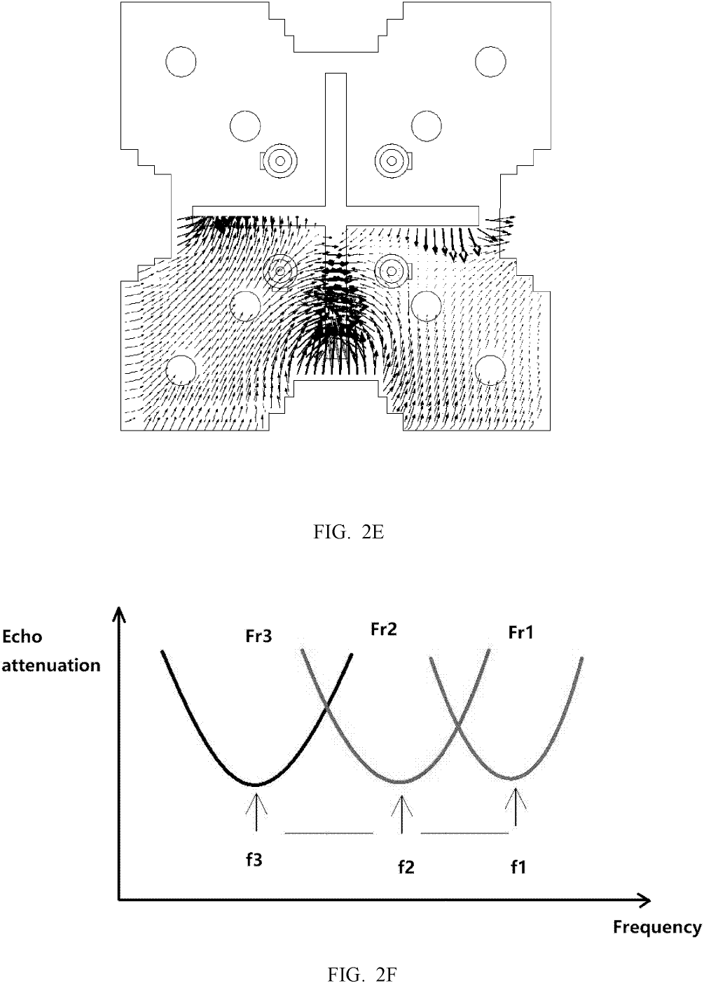

FIG. 2A is an exemplary diagram showing more details of the antenna radiator according to embodiments of the present disclosure.

As shown in FIG. 2A, the planar body 1 is basically in a form of square.

In embodiments of the present disclosure, the at least four radiation blocks comprise four radiation blocks (11, 12, 13, 14), as shown in FIG. 2A. However, it is also possible to have other number of radiation blocks.

In embodiments of the present disclosure, the at least four radiation blocks (11, 12, 13, 14) are symmetry with each other around the center of the planar body.

In embodiments of the present disclosure, the at least one slot 20 comprises a first slot (201&203) and second slot (202&204) basically perpendicular with each other; the first slot extends basically perpendicularly to a first outer side and a third outer side of the planar body, the third outer side is opposite to the first outer side; and the second slot extends basically perpendicularly to a second outer side and a fourth outer side of the planar body, the fourth outer side is opposite to the second outer side.

It should be understood, the part 201 and 203 may be considered as two continuous slots or just two continuous parts of one slot. Similarly, the part 202 and 204 may be considered as two continuous slots or just two continuous parts of one slot.

In embodiments of the present disclosure, two radiation blocks of the at least four radiation blocks located on a same diagonal line form a pair. For example, the first radiation block 11, and the third radiation block 13 form a pair, and the second radiation block 12, and the fourth radiation block 14 form another pair. Therefore, dual polarization may be achieved.

In embodiments of the present disclosure, the at least one notch 60 comprises: a first notch 61 located at the first outer side of the planar body 1; a second notch 62 located at the second outer side of the planar body 1; a third notch 63 located at the third outer side of the planar body 1; and a fourth notch 64 located at the fourth outer side of the planar body 1.

As shown in FIG. 2A, a notch comprises at least two rectangle parts adjacent in a depth direction; and the depth direction is basically perpendicular to the outer side of the planar body.

In embodiments of the present disclosure, a ratio of lengths of two adjacent rectangle parts of the at least two rectangle parts is a predetermined value; a ratio of depths of two adjacent rectangle parts of the at least two rectangle parts is the predetermined value; in the at least two rectangle parts, a first rectangle part further away from the outer side of the planar body has a first length less than a second length of a second rectangle part closer to the outer side of the planar body. For example, a first rectangle part 601 further away from the outer side of the planar body has a first length L1 less than a second length L2 of a second rectangle part 701 closer to the outer side of the planar body.

It should be understood that the predetermined value for the ratio of lengths, and the predetermined value for the ratio of depths may be different. But basically, the closer the two ratios are, the better to widen the frequency range of the antenna radiator. That is, the same value will be preferred.

In embodiments of the present disclosure, the notch is located with a distance to the at least one slot; and the distance is associated with predetermined value.

In embodiments of the present disclosure, the distance d0 is basically equal to

$$\frac{d 1}{β \times K} ;$$

and d1 is a depth of a rectangle part, that is closest to the at least one slot, among the at least two rectangle parts, K is the predetermined value, β is a tuning factor. The specific values of K and β may be determined according to practical applications.

Taking the first notch 61 as example, the first notch 61 comprises a first rectangle part 601 with a depth d1, and a length L1, and a second rectangle part 701 with a depth d2, and a length L2. The first rectangle part 601 has a distance d0 to the slot 201. There will be a relationship of

$$\frac{L 2}{L 1} = \frac{d 2}{d 1} = \frac{d 1}{β \times d 0} = K .$$

Similarly, the second notch 62 comprises a first rectangle part 602, and a second rectangle part 702. The third notch 63 comprises a first rectangle part 603, and a second rectangle part 703. The fourth notch 64 comprises a first rectangle part 604, and a second rectangle part 704.

For example, there may be L2/L1=6.7/5.6=1.196, d2/d1=1.34/1.12=1.196, d0=1.4, β =0.67. It should be understood that the specific value of the lengths and depth may be determined due to practical implementation. For example, a unit of the L1, L2, d1, d2, d0, etc. may be millimetre, mm.

In embodiments of the present disclosure, a length of any of the rectangle parts (e.g. L1, L2) may be greater than a width w of any of the slots.

In embodiments of the present disclosure, each of the at least four radiation blocks has at least one hole located on a diagonal line of the planar body.

For example, the first radiation block 11 has two holes 401, 501, the second radiation block 12 has two holes 402, 502, the third radiation block 13 has two holes 403, 503, and the fourth radiation block 14 has two holes 404, 504.

It should be understood the number of the holes is also not limited.

As shown in FIG. 2A, with more details, the planar body (patch) 1 is the sheet metal on which the surface current resides. The sheet metal contains four-quadrant function block and each functional block is rotational symmetry. There are slots and holes stamped on the planar body 1 and these structures are rotational symmetry as well. The slots (201,202,202,204) are carved on the planar body 1. Since surface current must reside on metal, the center at where the four slots (201, 202, 202, 204) joint with each other defines the zero-surface current position for the whole structure. The indented steps/notches are fabricated on the slots, to form a slow wave structure to tune the phase difference of the even mode and odd mode to realize a good isolation. Since on surface current can propagate cross the slots, the boundary for surface current are made. The surface current density originated from the zero-surface current potion, increasing along the slots to the edge of the planar body 1. Metal pins (301, 302, 303, 304) are soldered with the planar body 1. The sheet metal (1) are fed by the four pins with proper phase shifts to form different polarization type required by the wireless devices, such as a base station. According to the kirchhoff’s law, the four pins (301, 302, 303, 304) are fed pins and shorting pins simultaneously depending which objects are analyzed in the circuits model. Therefore, the four pins (301, 302, 303, 304) define a reflection boundary for sheet metal (1). Holes (401, 402, 403, 404) and (501, 502, 503, 504) are punched into the sheet metal (1). Since the surface currents cannot pass through a hole, these holes are used to improve the isolation of surface current excited in different quadrants. These holes (401, 501, 402, 502) are meant to manipulate the surface currents originated from slot (201) to flow towards the edge perpendicular to the slot (201) instead of the edge parallel with the slot (201). These holes (402, 502, 403, 503) are meant to manipulate the surface currents originated from slot (202) to flow towards the edge perpendicular to the slot (202) instead of the edge parallel with the slot (202). Those holes (403, 503, 404, 504) are meant to manipulate the surface currents originated from slot (203) to flow towards the edge perpendicular to the slot (203) instead of the edge parallel with the slot (203). These holes (404, 504, 401, 501) are meant to manipulate the surface currents originated from slot (204) to flow towards the edge perpendicular to the slot (204) instead of the edge parallel with the slot (204). The rectangle parts (601, 602, 603, 604) and (701, 702, 703, 704) of the notches (61, 62, 63, 64) etched on sheet metal (1). For example, the rectangle parts (601,701) form a stepping horn structure. The gradually varied metal boundary helps shaping the surface current to resonant along the exponential curve which will results a wider resonating bandwidth, i.e. a wider bandwidth of an antenna elements. The combination of depth of “d1”, the depth of “d2”, the length “L1”, the length “L2”, given in FIG. 2A defines the exponential index of exponential curve. Since exponential curve with different exponential index reports different resonant band width. By fine tuning the combination of “d1”, “d2” and “L1”, “L2”, different bandwidth, especially a wideband width can be realized. Further, the width “w” of a slot may be also tuned accordingly.

FIG. 2B is an exemplary diagram showing surface current distribution of the antenna radiator, according to embodiments of the present disclosure.

As shown in FIG. 2B, in the area from a slot to a notch, particularly along the edge of the notch, the strength of the surface current resonates so as to generate radiation.

That is, in the present disclosure, the step shaped notch can disperse the resonant current, instead of concentrating on the one point such as any edge of the notch or the slot. Thus, multiple resonance points (oblique in the planar body 1) are provided, and wider bandwidth may be generated by superimposing small ones generated by each resonance point.

The gradually varied metal boundary (the combination of the center slots and the two-stage stepping structure of notches) helps shaping the surface current to resonant along the exponential curve which will results a wider resonating bandwidth. Further, the two holes arranged along the diagonal line can reduce the weight and pull the current into a proper shape.

The length and depth of rectangle part of the notch (with gradual steps) of satisfy the logarithmic relation, so that the some small bandwidths may be superimposed into the wider bandwidth.

Further, four quadrants, and dual polarization antenna may be provided. Single polarization requires at least one pair of dipoles (two pieces), so dual polarization requires at least four pieces.

FIG. 2C is an exemplary diagram showing a magnetic field vector (H vector) direction of the surface current of the antenna radiator, according to embodiments of the present disclosure.

A H-vector plot is sampled for an instant and given in FIG. 2C. At this time point, H-vector originated from different edge of each rectangle part of the notch (601, 701, etc.) traveled along different paths, which reports different angle and length, to the cross-slots 20.

FIG. 2D is another exemplary diagram showing more details of the antenna radiator according to embodiments of the present disclosure.

As shown in FIG. 2D, a notch may further have a third rectangle part. For example, the first notch 61 further comprises a third rectangle part 801 with a depth d3, and a length L3 (not shown). There will be a relationship of

$$\frac{L 3}{L 2} = \frac{d 3}{d 2} = \frac{L 2}{L 1} = \frac{d 2}{d 1} = \frac{d 1}{β \times d 0} = K .$$

Similarly, the second notch 62 comprises a third rectangle part 802. The third notch 63 comprises a third rectangle part 803. The fourth notch 64 comprises a third rectangle part 804.

For example, there may be L3/L2=8.0/6.7=1.196, L2/L1=6.7/5.6=1.196, d3/d2=1.29/1.07=1.196, d2/d1=1.07/0.90=1.196, d0=1.12, β=0.67.

According to embodiments of the present disclosure, for example, the rectangle parts (601,701,801) provide a self-similar structure, so that the properties at some frequency f1=K*f2 were the same as at the first frequency f2 (and K is some constant greater than 1).

That is, it is designed that the ratio of the every successive two element lengths of the rectangle parts (801/701/601), (802/702/602), (803/703/603), (804/704/604) is equal to some constant k, and that the distance between every two elements of (d3/d2/d1/βd0) is also equal to k (where β is a matching factor to tune the surface current).

This isn’t quite a fractal, just some sort of structure that has some repetition to it.

This is a log periodic structure and can construct the surface current to distribute over an exponential curve which is specified over angles.

FIG. 2E is another exemplary diagram showing a magnetic field vector (H vector) direction of the surface current of the antenna radiator, according to embodiments of the present disclosure.

A H-vector plot is sampled for an instant and given in FIG. 2C. At this time point, H-vector originated from different edge of each rectangle part of notch (601, 701, 801, etc.) traveled along different path, which reports different angle and length, to the cross-slots.

FIG. 2F is an exemplary diagram showing a bandwidth of the antenna radiator, according to embodiments of the present disclosure.

Referring to FIGS. 2D and 2F, a position of frequency f1 may be determined by a length of the rectangle part 601 (602, 603, 604). Similarly, a position of frequency f2 may be determined by a length of the rectangle part 701 (702, 703, 704). A position of frequency f3 may be determined by a length of the rectangle part 801 (802, 803, 804). A distance between f1 and f2 may be determined by a ratio of a depth of the rectangle part 701 (702, 703, 704) to a depth of the rectangle part 601 (602, 603, 604). Similarly, a distance between f2 and f3 may be determined by a ratio of a depth of the rectangle part 801 (802, 803, 804) to a depth of the rectangle part 701 (702, 703, 704). Further, there may be a relationship of f1=K*f2, etc., as described above.

As shown in FIG. 2F, the total frequency range Fr1 + Fr2 + Fr3 included by the curves may be considered as the available frequency bandwidth. Therefore, by adding the rectangle part in the notch, and/or adjusting the shape of the rectangle part, the frequency bandwidth may be enlarged without creasing the overall size of the antenna radiator.

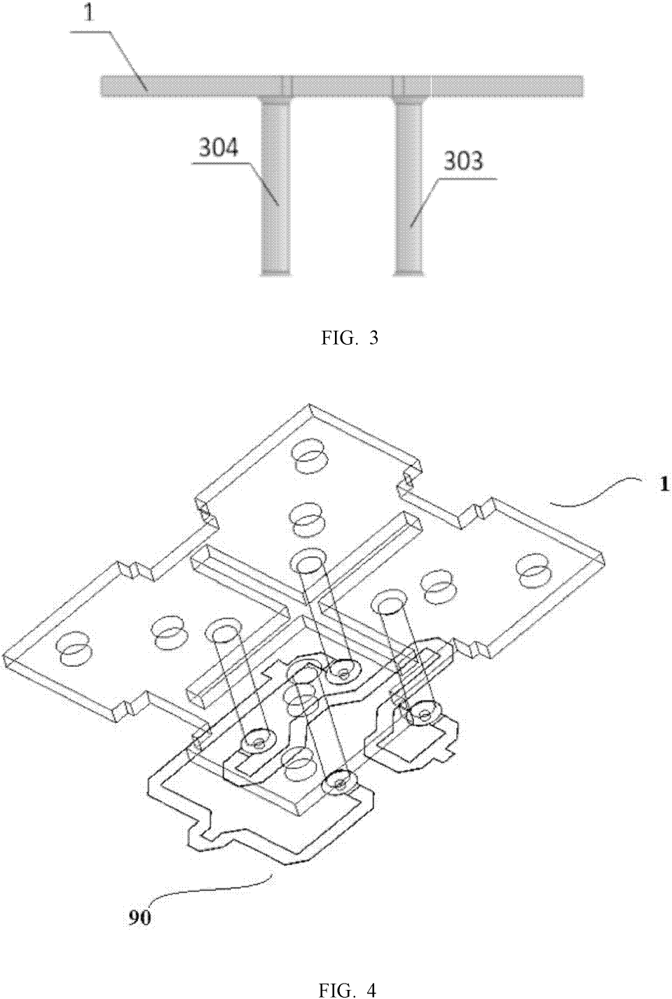

FIG. 3 is an exemplary diagram showing a side view of an antenna radiator according to embodiments of the present disclosure.

In embodiments of the present disclosure, a feeding point of each of the at least four radiation blocks is located on a diagonal line of the planar body.

In embodiments of the present disclosure, the feeding point is connected to feeding network though a feeding pin; the feeding pin further supports the each of the at least four radiation blocks with a height over a dielectric substrate.

For example, the first radiation block 11 has a feeding point connected to a feeding pin 301, the second radiation block 12 has a feeding point connected to a feeding pin 302, the third radiation block 13 has a feeding point connected to a feeding pin 303, and the fourth radiation block 14 has a feeding point connected to a feeding pin 304.

The four pins (301, 302, 303, 304) are perpendicular to the sheet metal (1). The four pins can be connected either to a RF exciting source or a ground.

FIG. 4 is an exemplary diagram showing an antenna according to embodiments of the present disclosure.

As shown in FIG. 4, the antenna comprises an antenna radiator 1 according to any embodiment of the present disclosure, such as shown in FIGS. 1 to 3; and a dielectric substrate (not shown). The antenna radiator 1 is electrically coupled to a feeding network 90 (particularly a T type power divider) arranged on the dielectric substrate.

In embodiments of the present disclosure, the antenna further comprises a grounded metal plate (not shown) arranged on the dielectric substrate.

For example, one side of a print circuit board (PCB) may be used for constructing the radiator, and on the other side the ground metal plate may be provided. It is also possible to conduct copper clad ground treatment on the PCB on the same side of the radiator.

According to embodiments of the present disclosure, an arrangement of the at least one slot and the at least one notch may provide the antenna radiator with capability to specify the surface currents’ distribution on the antenna radiator. Therefore, the frequency bandwidth of the antenna radiator may be enlarged by adjusting the shape of the at least one slot and/or the at least one notch, without enlarging the overall size of the antenna radiator.

According to embodiments of the present disclosure, an improved antenna radiator, particularly, a four-quadrant log-periodic surface current constraining structure may be achieved.

To increase a structure’s resonant frequency is to manipulate its surface current’s distribution pattern. In general, an exponential curved surface current reports much wider bandwidth than a linear cured surface current. The present disclosure introduces structures that can constrain the surface current’s boundary and tune the exponential index of the exponentially curved surface current, namely, a surface current distribution of a wide band resonating structure.

The proposed surface constraining structure can manipulate the surface current on the radiator to resonant in an exponential curve which depend on angles instead of wavelength. By this means, a wide bandwidth can be realized within the compact size.

Further, those notch, holes and slots can be carved by stamping process. The weight of the radiator can be reduced.

Further, the four quadrant sectors are rotational symmetry which can benefit the cross-polarization ratio.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. An antenna radiator, comprising:
a planar body;
at least one slot located in the planar body; and
at least one notch located on at least one outer side of the planar body, respectively;
wherein the at least one slot crosses a center of the planar body, to basically divide the planar body to at least four radiation blocks ;
wherein a notch of the at least one notch is located between two adjacent radiation blocks of the at least four radiation blocks; and
wherein a length direction of the notch extends along an outer side of the planar body at which the notch is located.

2. The antenna radiator according to claim 1,
wherein the notch comprises at least two rectangle parts adjacent in a depth direction; and
wherein the depth direction is basically perpendicular to the outer side of the planar body.

3. The antenna radiator according to claim 2,
wherein a ratio of lengths of two adjacent rectangle parts of the at least two rectangle parts is a predetermined value;
wherein a ratio of depths of two adjacent rectangle parts of the at least two rectangle parts is the predetermined value; and
wherein in the at least two rectangle parts, a first rectangle part further away from the outer side of the planar body has a first length less than a second length of a second rectangle part closer to the outer side of the planar body.

4. The antenna radiator according to claim 3,
wherein the notch is located with a distance to the at least one slot; and
wherein the distance is associated with predetermined value.

5. The antenna radiator according to claim 4,
wherein the distance d0 is basically equal to d1/(β×K); and
wherein d1 is a depth of a rectangle part, that is closest to the at least one slot, among the at least two rectangle parts, K is the predetermined value, β is a tuning factor.

6. The antenna radiator according to claim 1, wherein the planar body is basically in a form of square.

7. The antenna radiator according to claim 6,
wherein the at least one slot comprises a first slot and second slot basically perpendicular with each other;
wherein the first slot extends basically perpendicularly to a first outer side and a third outer side of the planar body, the third outer side is opposite to the first outer side; and
wherein the second slot extends basically perpendicularly to a second outer side and a fourth outer side of the planar body, the fourth outer side is opposite to the second outer side.

8. The antenna radiator according to claim 7, wherein the at least one notch comprises:
a first notch located at the first outer side of the planar body;
a second notch located at the second outer side of the planar body;
a third notch located at the third outer side of the planar body; and
a fourth notch located at the fourth outer side of the planar body.

9. The antenna radiator according to claim 7,
wherein the at least four radiation blocks comprises four radiation blocks.

10. The antenna radiator according to claim 1,
wherein each of the at least four radiation blocks has at least one hole located on a diagonal line of the planar body.

11. The antenna radiator according to claim 1,
wherein a feeding point of each of the at least four radiation blocks is located on a diagonal line of the planar body.

12. The antenna radiator according to claim 11,
wherein the feeding point is connected to feeding network though a feeding pin ;
wherein the feeding pin further supports the each of the at least four radiation blocks with a height over a dielectric substrate.

13. The antenna radiator according to claim 1,
wherein the at least four radiation blocks are in symmetry with each other around the center of the planar body.

14. The antenna radiator according to claim 13,
wherein two radiation blocks of the at least four radiation blocks located on a same diagonal line form a pair.

15. An antenna, comprising:
an antenna radiator according to claim 1; and
a dielectric substrate;
wherein the antenna radiator is electrically coupled to a feeding network arranged on the dielectric substrate.

16. The antenna according to claim 15, further comprising a grounded metal plate arranged on the dielectric substrate.
